(19) United States
(12) Patent Application Publication
(10) Pub. No.: US 2019/0051870 A1
(43) Pub. Date: Feb. 14, 2019

(54) BATTERY PACK CARRYING DEVICE AND METHOD

(71) Applicant: Lily Rutledge, Maple Ridge (CA)

(72) Inventor: Lily Rutledge, Maple Ridge (CA)

(21) Appl. No.: 15/675,574

(22) Filed: Aug. 11, 2017

(51) Int. Cl. H01M 2/10; H02J 7/00; H02J 7/14

(52) U.S. Cl. CPC H01M 2/1077; H01M 2/1011; H02J 7/0027; B60L 2230/10; H01M 2220/20; H02J 2007/0067; H02J 7/1423

(57) ABSTRACT

A carrying device includes a casing configured to house the battery pack and a rubber bumper removably coupled to the casing. The carrying device is configured to carry a battery pack inside an electric vehicle. In addition, the carrying case portable and removable from the electric vehicle. The carrying device is useful for providing a rechargeable and interchangeable battery pack system for electric vehicles that may help to eliminate range anxiety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of power supply systems of existing art and more specifically relates to electric vehicle portable batteries.

### RELATED ART

Various strategies have emerged in the quest to develop commercially viable, energy advantageous vehicles that use electrical energy in full or in part to propel the vehicle. Of great interest in the context of this invention is the way in which electrical energy is stored, controlled, and replenished in these different strategies.

The battery electric vehicle (BEV) is similar to a plug-in hybrid electric vehicle but lacks the combustion engine component. Batteries and the electric drive are the sole source of propulsion for the BEV. Replenishment is by plug-in only, and as previously stated, only when the vehicle is at rest near an electrical source. Current BEVs are best suited to short- and mid-range cycles of operation (20 to 200 mile range) requiring recharging periods of several to many hours in between excursions. A suitable solution is desired.

U.S. Pat. No. 8,796,987 to Karl F. Scheucher relates to a refuelable battery-powered electric vehicle. The described refuelable battery-powered electric vehicle includes an energy storage system that permits the electric refueling of the electric vehicle just like an automobile would be refueled with gasoline at a gas station. Circuitry on board the vehicle accessible by the electric refueling station enables the determination of the energy content of the battery module or modules returned to the electric refueling station and the owner of the vehicle is given credit for the energy remaining in the battery module or modules which have been exchanged. Selective refueling may take place for given battery modules by removing them from the battery system and charging them at home, office or factory. A process for operating an electric vehicle is also disclosed and claimed.

### SUMMARY OF THE INVENTION

In view of the foregoing disadvantages inherent in the known power supply system art, the present disclosure provides a novel battery pack carrying device and method. The general purpose of the present disclosure, which will be described subsequently in greater detail, is to provide an interchangeable and rechargeable battery pack system for electric vehicles.

A carrying device is disclosed herein. The carrying device may include a casing configured to house a battery pack and a rubber bumper removably coupled to the casing. The carrying device may be configured to carry the battery pack for an electric vehicle.

A carrying device for carrying a battery pack inside an electric vehicle is also disclosed herein. The carrying device for carrying a battery pack inside an electric vehicle may include a casing configured to house the battery pack and a rubber bumper removably coupled to the casing. The carrying device may be configured to carry a battery pack inside an electric vehicle. The carrying case may further be portable and removable from the electric vehicle.

According to another embodiment, a method of removing and recharging a battery pack for electric vehicles is also disclosed herein. The method of removing and recharging a battery pack for electric vehicles may include operating an electric vehicle into a service station, locating a battery recharging bay at a service station, driving into the battery recharging bay, removing the battery pack from said electric vehicle, fully depleting said battery pack, and fully recharging the battery pack.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a battery pack carrying device and method, constructed and operative according to the teachings of the present disclosure.

FIG. 1A is a front view of the carrying device, according to an embodiment of the disclosure.

FIG. 1B is a perspective view of the carrying device, according to an embodiment of the disclosure.

FIG. 2 is a top view of the carrying device of FIGS. 1A and 1B, according to an embodiment of the present disclosure.

FIG. 3 is a top view of the carrying device of FIGS. 1A and 1B, according to an embodiment of the present disclosure. This figure may also serve to illustrate an embodiment of a battery recharging bay that may be configured for use in a home or at a service station.

FIG. 4 is a flow diagram illustrating a method of removing and recharging a battery pack for electric vehicles, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to power supply systems and more particularly to a battery pack carrying device and method as used to provide a rechargeable and interchangeable battery pack system for electric vehicles that may help to eliminate ‘range anxiety’.

Generally, the battery pack carrying device may include a rechargeable and interchangeable battery pack system for electric vehicles. The battery packs may be exchanged for charged battery packs at existing service stations, thereby helping to eliminate vehicle range anxiety. Participating service stations may sell charged battery packs that can quickly be exchanged for depleted battery packs

Electric vehicles are growing in popularity with consumers, however many consumers and electric vehicle users still face the vehicle range anxiety barrier. Even with an abundance of electric vehicle charging stations, electric vehicles still may require time to sit and recharge. The battery pack carrying device and method of this disclosure may make it possible for electric vehicle owners to quickly add battery life to their car in less time than it takes to fill the tank of a gas-powered vehicle. The participating service stations may own and operate battery recharging bays that may be configured to fully deplete and then recharge existing battery packs. Electric vehicle drivers may have battery bays in the form of the carrying device inside of their vehicles in order to accommodate the individual battery packs.

The battery pack carrying device may be configured as a portable system. The device can be removed from a car by the consumer and left in the garage if desired. This may be done when the consumer wants the trunk space or does not want the extra weight of the device in their car. The in-car device may rest in the trunk of the car, with a holder where it fits in the trunk of the car in a designated space. The device may include a rubber bumper on all four corners of the device, or a rubber bumper that completely surrounds the base of the device. The device may also include a plug or wire connection installed in the trunk of the car that allows the device to be connected to the main battery system of the car.

The charging apparatus featured and operated at designated service stations may include a mechanism that drains electricity from the batteries arriving at the service station. This feature may allow the batteries to be charged up from zero to fully charged. A charging device (such as the one at the service stations) could also be purchased for home (in-garage) use. The extra batteries could be used for a quick change of electrical power at home, before departing again quickly. More importantly, the extra batteries could be available in the event of a power outage, in order to give the car enough electricity to get to the next service centre. Given human nature, the extra batteries could also be used in the morning after a night when someone forgot to plug in their car overnight. The consumer may then be able to get on with their day without waiting for the car to charge.

The included battery bays of the battery pack carrying device may include a customizable array of up to 5 battery bays configured to receive an individual battery pack. The individual battery packs may feature battery contact points at the bottom end, which may align with contact points built in to the bottom of the battery bay. The individual battery packs may further include handles for carrying and removing the battery packs from the battery bay. Further still, the individual battery packs may include charge indicator lights. The charge indicator lights may feature decorative indicia and other images that may resemble a happy face or smiley face.

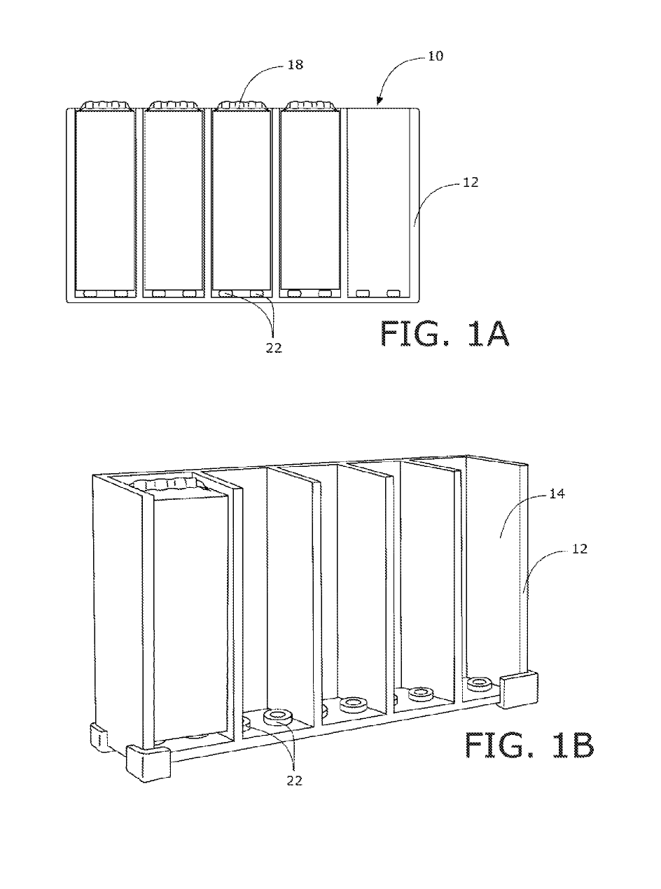

Referring now more specifically to the drawings by numerals of reference, there is shown in FIGS. 1A-3, various views of a carrying device 10 for carrying a battery pack for an electric vehicle.

FIG. 1A shows a carrying device 10 during an ‘in-use’ condition, according to an embodiment of the present disclosure. Here, the carrying device 10 may be beneficial for use by a user to provide a rechargeable and interchangeable battery pack system for electric vehicles that may help to eliminate range anxiety. As illustrated, the carrying device 10 may include a casing 12 configured to house at least one battery pack. The carrying device 10 may be portable by design and may further be configured for placement in the trunk of an electric vehicle (not pictured). The battery packs may feature a handle 18 for removing and transporting the battery packs. The carrying device 10 may further include battery contact points 22 that may be configured to allow transfer of a charge into and from the battery packs.

FIG. 1B shows the carrying device 10 from an alternate perspective according to an embodiment of the present disclosure. As shown, the carrying device 10 may include a casing 12 having a plurality of battery bays 14 configured to receive and retain battery packs. Again, the casing may feature battery contact points 22 for the transfer of a charge into and from the included battery packs.

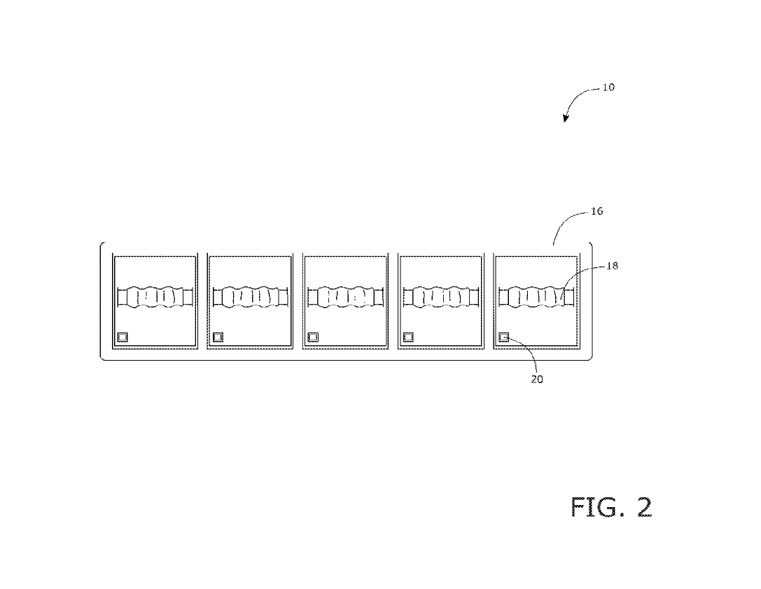

FIG. 2 shows the carrying device 10 of FIGS. 1A and 1B, according to an embodiment of the present disclosure. As above, the carrying device 10 may include a battery pack 16 inserted into the carrying device 10. Each battery pack 16 may include a handle 18 at the top end of the battery pack 16. The handle 18 may be provided as an easy means for removal of the battery pack 16 from the carrying device 10. Each battery pack 16 may also include a charge indicator light 20 at the top end of the battery pack 16. The charge indicator light 20 may be configured as a means for alerting a user when the battery pack 16 may be low in charge.

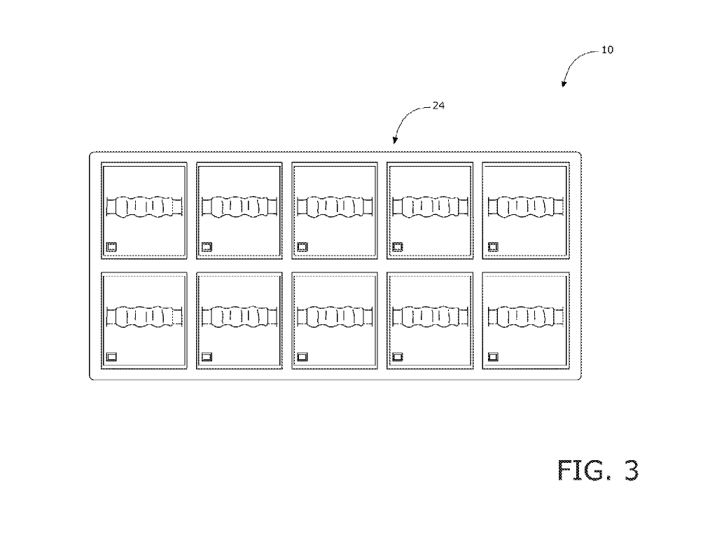

FIG. 3 is a top view of the carrying device 10 of FIGS. 1A and 1B, according to an embodiment of the present disclosure. This figure illustrates an embodiment of a battery recharging bay 24 that may be configured for use in a home or at a service station.

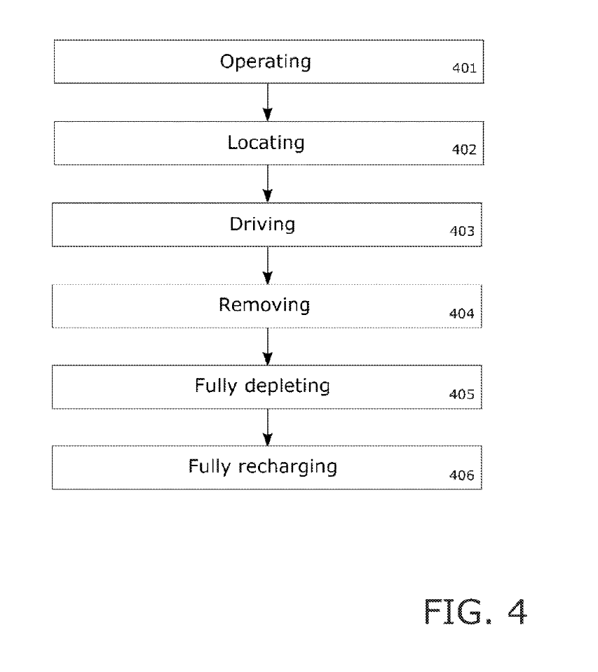

FIG. 4 is a flow diagram illustrating a method of removing and recharging 400 a battery pack for electric vehicles, according to an embodiment of the present disclosure. In particular, the method of removing and recharging a battery pack for electric vehicles may include one or more components or features of the carrying device 10 as described above. As illustrated, the method of removing and recharging a battery pack for electric vehicles may include the steps of: step one 401, operating an electric vehicle into a service station; step two 402, locating a battery recharging bay at the service station; step three 403, driving into the battery recharging bay; step four 404, removing said battery pack from said electric vehicle; step five 405, fully depleting the battery pack; and step six 406, fully recharging the battery pack.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the carrying device, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A carrying device for carrying a battery pack for an electric vehicle, said carrying device comprising:
a casing, said casing configured to house said battery pack;
a rubber bumper, said rubber bumper being removably coupled to said casing;
and wherein said carrying device is configured to carry said battery pack for said electric vehicle.

2. The carrying device of claim 1, wherein said carrying device is portable.

3. The carrying device of claim 1, wherein said carrying device is able to be removed from said electric vehicle.

4. The carrying device of claim 1, wherein said carrying device is locatable in a trunk of said electric vehicle.

5. The carrying device of claim 1, wherein said rubber bumper is located on a plurality of corners of said carrying device.

6. The carrying device of claim 1, wherein said rubber bumper completely surrounds a base of said carrying device.

7. The carrying device of claim 1, wherein said casing includes at least one battery bay.

8. The carrying device of claim 1, wherein said casing includes 5 battery bays.

9. The carrying device of claim 1, wherein said battery pack includes a plurality of batteries.

10. The carry device of claim 9, wherein each of said plurality of batteries includes a handle, said handle located on a top end of said battery.

11. The carrying device of claim 10, wherein said handle is configured to provide an easy means for removal of said battery from said carrying device.

12. The carrying device of claim 10, wherein each of said plurality of batteries includes a means for alerting a user when said battery is low in charge.

13. The carrying device of claim 12, wherein said means for alerting is a charge indicator light.

14. The carrying device of claim 10, wherein each of said plurality of batteries includes battery contact points, said battery contact points configured to allow transfer of charge into said battery.

15. A carrying device for carrying a battery pack inside an electric vehicle, said carrying device comprising:
a casing, said casing configured to house said battery pack;
a rubber bumper, said rubber bumper being removably coupled to said casing;
and wherein said carrying device is configured to carry a battery pack for said electric vehicle, wherein said carrying device is portable;
wherein said carrying device can be removed from said electric vehicle;
wherein said carrying device is located in a trunk of said electric vehicle;
wherein said rubber bumper is located on a plurality of corners of said carrying device;
wherein said rubber bumper completely surrounds a base of said carrying device;
wherein said casing includes at least one battery bay;
wherein said casing includes 5 of said battery bays;
wherein said battery pack includes a plurality of batteries;
wherein each of said plurality of batteries includes a handle, said handle located on a respective top end of said battery;
wherein said handle is configured to provide an easy means of removal of the battery from said carrying device;
wherein each of said plurality of batteries includes a means for alerting a user when a battery is low in charge;
wherein said means for alerting said user is a charge indicator light; and
wherein each of said plurality of batteries includes battery contact points, said battery contact points configured to allow transfer of charge into said battery.

16. A method of removing and recharging a battery pack for electric vehicles to prevent range anxiety, comprising the steps of:
operating an electric vehicle into a service station;
locating a battery recharging bay at said service station;
driving into said battery recharging bay;
removing said battery pack from said electric vehicle;
fully depleting said battery pack; and
fully recharging said battery pack.

17. The method of removing and recharging a battery pack of claim 16, wherein said battery recharging bay at said service station houses at least 10 batteries.

18. The method of removing and recharging a battery pack of claim 17, wherein after said fully recharging of said battery pack occurs, said battery pack is sold to operators of said electric vehicle drivers.

19. The process of removing and recharging a battery pack of claim 18, wherein said electric vehicle drivers is able to store said battery pack in a battery bay housed in said electric vehicle.
